(19) United States
(12) Patent Application Publication
(10) Pub. No.: US 2022/0230364 A1
(43) Pub. Date: Jul. 21, 2022

(54) Method And Apparatus For Processing Radar Image

(71) Applicant: SI Analytics Co., Ltd., Daejeon (KR)

(72) Inventors: Hyunguk CHOI, Daejeon (KR); Minyoung BACK, Daejeon (KR)

(73) Assignee: SI Analytics Co., Ltd., Daejeon (KR)

(21) Appl. No.: 17/576,621

(22) Filed: Jan. 14, 2022

(30) Foreign Application Priority Data
Jan. 19, 2021 (KR) 10-2021-0007565
Mar. 25, 2021 (KR) 10-2021-0038642

(51) Int. Cl. G06T 11/00; G06V 10/764; G06V 10/774; G06V 10/10; G06V 10/82; G01S 13/90; G06N 3/08

(52) U.S. Cl. CPC G06T 11/00; G06V 10/764; G06V 10/7747; G06N 3/08; G06V 10/82; G01S 13/90; G06V 10/16

(57) ABSTRACT

Disclosed is a method for processing a radar image performed by a computing device including at least one processor. The method may include: creating a first polarization image by performing a first decomposition operation with respect to an input radar image; creating a synthetic image through an image creation model based on the input radar image; and creating result information through an image processing model based on the first polarization image and the synthetic image.

### CROSS-REFERENCE TO RELATED APPLICATIONS

This application claims priority to and the benefit of Korean Patent Application No. 10-2021-0007565 filed in the Korean Intellectual Property Office on Jan. 19, 2021, and of Korean Patent Application No. 10-2021-0038642 filed in the Korean Intellectual Property Office on Mar. 25, 2021, the entire contents of which are incorporated herein by reference.

### TECHNICAL FIELD

The present disclosure relates to a method for processing a radar image, and more particularly, to a method for processing a radar image using an artificial neural network.

### BACKGROUND ART

A synthetic aperture radar means a radar system that calculates a distance by using a fine time difference between sequentially shooting a radar while moving in the air, and then reflecting and returning of a radar wave on a ground surface, and creates a topographic map.

However, a radar image created based on the synthetic aperture radar system includes substantial part of noise, and as a result, there is a problem in that it is difficult to easily distinguish a boundary of an object only with the radar image. Further, accuracy of an object detection technique using an artificial neural network could not exceed a predetermined level or more with respect to the radar image.

Accordingly, in the art, various methods for increasing accuracy of a method for detecting a target object from the radar image by using the artificial neural network have been studied.

Korean Patent Registration No. KR171373 discloses “Method and Apparatus for Detecting Moving Object”.

### SUMMARY OF THE INVENTION

The present disclosure is contrived in response to the above-described background art, and has been made in an effort to provide a method for processing a radar image using an artificial neural network.

An exemplary embodiment of the present disclosure provides a method for processing a radar image performed by a computing device including at least one processor. The method may include: creating a first polarization image by performing a first decomposition operation with respect to an input radar image; creating a synthetic image through an image creation model based on the input radar image; and creating result information through an image processing model based on the first polarization image and the synthetic image.

In an alternative exemplary embodiment, the creating of the result information may include overlapping the first polarization image and the synthetic image, and inputting the images into the image processing model.

In an alternative exemplary embodiment, the input radar image may be a synthetic aperture radar (SAR) image.

In an alternative exemplary embodiment, the image creation model may be learned based on a generative adversarial neural network algorithm.

In an alternative exemplary embodiment, the image creation model may be learned based on a learning method including creating, by the image creation model, the synthetic image from a polarization image created based on a radar image, and discriminating, by an image discrimination model, an actual optical image photographed through an optical sensor, and the synthetic image.

In an alternative exemplary embodiment, the creating of the synthetic image may include creating the synthetic image by inputting the first polarization image into the image creation model.

In an alternative exemplary embodiment, the creating of the synthetic image may include creating a second polarization image by performing a second decomposition operation with respect to the input radar image, and creating the synthetic image by inputting the second polarization image into the image creation model, and the second decomposition operation may be based on a different algorithm from the first decomposition operation.

In an alternative exemplary embodiment, the first decomposition operation or the second decomposition operation may include an operation of decomposing scattering data for at least one pixel included in the input radar image.

In an alternative exemplary embodiment, the result information may include a classification result for each of one or more pixels included in the input radar image.

In an alternative exemplary embodiment, the inputting may include creating a combination image by sequentially combining the first polarization image and the synthetic image.

Another exemplary embodiment of the present disclosure provides a computer program stored in a computer-readable storage medium. The computer program executes the following operations for processing a radar image when the computer program is executed by one or more processors, and the operations may include: creating a first polarization image by performing a first decomposition operation with respect to an input radar image; creating a synthetic image through an image creation model based on the input radar image; and creating result information through an image processing model based on the first polarization image and the synthetic image.

Still another exemplary embodiment of the present disclosure provides an apparatus for processing a radar image. The apparatus may include: one or more processors; a memory storing an image creation model including one or more neural networks and an image processing model including one or more neural networks; and a network unit, and the one or more processors may be configured to create a first polarization image by performing a first decomposition operation with respect to an input radar image, create a synthetic image through an image creation model based on the input radar image, and create result information through an image processing model based on the first polarization image and the synthetic image.

According to exemplary embodiments of the present disclosure, a method for processing a radar image using an artificial neural network can be provided.

### BRIEF DESCRIPTION OF THE DRAWINGS

FIG. 1 is a block diagram of a computing device for processing a radar image according to an exemplary embodiment of the present disclosure.

FIG. 2 is a schematic diagram illustrating a network function according to an exemplary embodiment of the present disclosure.

FIG. 3 is an exemplary diagram illustrating a state of an image according to each step of image processing.

FIG. 4 is a flowchart for a process of creating result information from an input radar image by a computing device according to an exemplary embodiment of the present disclosure.

FIG. 5 is a normal and schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

In the present disclosure, a “radar image” may include an image created based on a radar signal received by a computing device. In general, radio detection and ranging (RADAR) includes both a transmitter component and a receiver component, and has detection of a location or a direction of an object and measurement of a distance or a speed as a main function. Among them, measurement of the distance and the speed of a detected object is based on measurement of a propagation speed and a required propagation time of a radio wave, and frequency shift by a Doppler effect included in the reflected or scattered radio wave, respectively. In the present disclosure the image created based on the radar signal means an image created based on information of the received radio signal when a radar transmitter transmits the radio signal, and then a radar receiver receives the radio signal reflected from a target object. The information of the radio signal may include, for example, a direction, a size, a frequency, a scattering degree, etc., of the radio wave.

In the present disclosure, the “input radar image” may be a term used for referring to the radar image input into the computing device by a user in order to obtain the result information. In an exemplary embodiment of the present disclosure, the input radar image may be a synthetic aperture radar (SAR) image. The synthetic aperture radar is one type of radar which sequentially synthesizes a pulse wave which is reflected and returned on a ground or a curved surface of the ocean as sequentially transmitting the pulse wave to the ground or the ocean according to the fine time difference to create a ground topographic map.

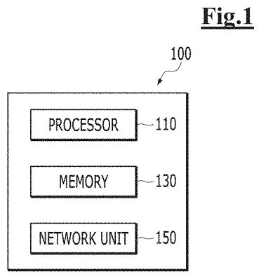

FIG. 1 is a block diagram of a computing device for processing a radar image according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a processor 110, a memory 130, and a network unit 150.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to an exemplary embodiment of the present disclosure. The processor 110 may create a first polarization image by performing a first decomposition operation with respect to the input radar image. In the present disclosure, the “input radar image” means a radar image input into the computing device 100 for processing. In the present disclosed contents, terms “first,” “second,”, and the like are used to differentiate a certain component from other components, but the scope of should not be construed to be limited by the terms. For example, the first decomposition operation may be referred to as a second decomposition operation, and similarly, the second decomposition operation may also be referred to as the first decomposition operation. A specific method of a decomposition operation will be described below in detail. The processor 110 may create a synthetic image through an image creation model based on the input radar image. The processor 110 may create result information through an image processing model based on the first polarization image and the synthetic image.

According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of a plurality of computing devices may be used together to process the learning of the network function and the data classification using the network function. Further, the computer program executed in the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

In the present disclosure, the network unit 150 may use various communication systems regardless a communication aspect such as wired and wireless.

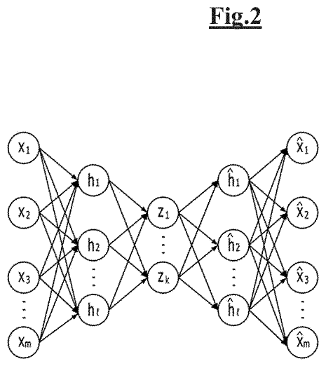

FIG. 2 is a schematic diagram illustrating a network function according to an exemplary embodiment of the present disclosure. At least a part of the image creation model or the image processing model according to the present disclosure may be based on a network function to be described below.

Throughout the present specification, a model, a neural network, an artificial neural network, a network function, and a neural network may be used as the same meaning. The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to still another exemplary embodiment of the present disclosure, the number of nodes of the input layer may be larger than the number of nodes of the output layer, and the neural network may be a neural network of a type in which the number of nodes increases from the input layer to the hidden layer. The neural network according to yet another exemplary embodiment of the present disclosure may be a neural network of a type in which the neural networks are combined.

The neural network according to an exemplary embodiment of the present disclosure may include a plurality of neural network layers. The neural network layers may constitute a sequence having a predetermined order according to a function and a role in the neural network. The plurality of neural network layers may include a convolutional layer, a pooling layer, a fully connected layer, etc. An initial input for the neural network may be received by a lowest initial layer in the sequence. The neural network may sequentially input the initial input into the layers in the sequence in order to create a final output from the initial input. The initial input may be, for example, an image, and a final output therefor may be, for example, a score for each category in a category set including one or more categories.

The neural network layer according to an exemplary embodiment of the present disclosure may include a set of nodes. Each neural network layer may receive the initial input for the convolutional neural network or an output of a previous neural network layer as an input. For example, in the sequence constituted by the plurality of neural network layers, an N-th neural network layer may receive an output of an N−1-th neural network layer as the input. Each neural network layer may create the output from the input. When the neural network layer is a highest final neural network layer in the sequence, the output of the neural network layer may be treated as an output of an entire neural network.

In the present disclosure, a term called a “feature map” may be used as a term referring at least a part of a result value of a convolutional operation. The neural network layer may include one or more filters for the convolutional operation. The feature map may be used as a term that refers a result of performing the convolutional operation by using one of one or more filters included in the neural network layer. A size of an output dimension of the neural network layer may be equal to the number of filters included in the neural network layer.

A deep neural network (DNN) may refer to a neural network that includes a plurality of hidden layers in addition to the input and output layers. When the deep neural network is used, the latent structures of data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The description of the deep neural network described above is just an example and the present disclosure is not limited thereto.

In an exemplary embodiment of the present disclosure, the network function may include the auto encoder. The auto encoder may be a kind of artificial neural network for outputting output data similar to input data. The auto encoder may include at least one hidden layer and odd hidden layers may be disposed between the input and output layers. The number of nodes in each layer may be reduced from the number of nodes in the input layer to an intermediate layer called a bottleneck layer (encoding), and then expanded symmetrical to reduction to the output layer (symmetrical to the input layer) in the bottleneck layer. The auto encoder may perform non-linear dimensional reduction. The number of input and output layers may correspond to a dimension after preprocessing the input data. The auto encoder structure may have a structure in which the number of nodes in the hidden layer included in the encoder decreases as a distance from the input layer increases. When the number of nodes in the bottleneck layer (a layer having a smallest number of nodes positioned between an encoder and a decoder) is too small, a sufficient amount of information may not be delivered, and as a result, the number of nodes in the bottleneck layer may be maintained to be a specific number or more (e.g., half of the input layers or more).

The neural network may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

In an exemplary embodiment of the present disclosure, the processor 110 may create a first polarization image by performing a first decomposition operation with respect to the input radar image.

In the present disclosure, the decomposition operation may include an operation of creating image data having an RGB value for each pixel from the image data including a radar signal value for each pixel. The radar signal value for each pixel may include values according to a plurality of types. In the present disclosure, the ‘radar signal value’ may be used by being exchanged with ‘scattering data’. The radar signal value for each pixel may include a VV value, an HH value, a VH value, and an HV value. V is an abbreviation of vertical and H as an abbreviation of horizontal means a direction of an electric field in the radio wave. That is, the VV value means a value of a vertically transmitted and vertically received pulse wave. The HH value means a value of a horizontally transmitted and horizontally received pulse wave. Similarly, the VH value means a value of a vertically transmitted and horizontally received pulse wave.

In the present disclosure, the decomposition operation may include a plurality of decomposition operations differently distinguished according to a method of the operation or a type of value which becomes an operation target. In the present disclosure, the decomposition operation may be a term used for comprehensively referring to the plurality of decomposition operations. The decomposition operation according to the present disclosure may include, for example, Pauli decomposition, Sinclair decomposition, Cameron decomposition, etc. An example for the decomposition operation described above is just an example and includes various decomposition techniques without a limitation.

In the present disclosure, the decomposition operation may include an operation of decomposing scattering data for at least one pixel included in the input radar image. The scattering data may be expressed as in a matrix of Equation 1, for example.

$$S = [ \begin{matrix}{S}_{HH} & {S}_{HV} \\ {S}_{VH} & {S}_{VV}\end{matrix} ] \qquad [ Equation 1 ]$$

In Equation 1, S represents a scattering data matrix for one random pixel. An expression of S_{XY} represents a value when transmitting X-direction polarization and receiving Y-direction polarization.

According to an exemplary embodiment of the present disclosure, a polarization image created by the processor 110 may be an optical image. The polarization image may be an image having an RGB value. In the present disclosed contents, an RGB image may have an RGB value for each pixel. A color of each pixel may be determined according to a combination of values corresponding to Red, Green, and Blue, respectively. For example, a pixel having an RGB value of (255, 0, 0) may be determined as a red color. As another example, a pixel having an RGB value of (238, 130, 238) may be determined as a purple color. An example of the above-described RGB value is just an example, and does not limit the present disclosure.

In a first exemplary embodiment of the decomposition operation for creating the polarization image according to the present disclosure, the processor 110 may determine the RGB value for each of a plurality of pixels included in the input radar image. The processor 110 may determine a Red value of the corresponding pixel by calculating a value of S_{HH}² from the scattering data of the pixel. The processor 110 may determine a Green value of the corresponding pixel by calculating a value of S_{VV}² from the scattering data of the pixel. The processor 110 may determine a Blue value by calculating a value of 2*S_{HV}² from the scattering data of the pixel. The processor 110 may determine the RGB value of the pixel on the polarization image corresponding to the location of each pixel of the input radar image according to the first exemplary embodiment.

In a second exemplary embodiment of the decomposition operation for creating the polarization image according to the present disclosure, the processor 110 may determine the RGB value for each of the plurality of pixels included in the input radar image. The processor 110 may determine the Red value of the corresponding pixel by calculating a value of S_{HH}−S_{VV} from the scattering data of the pixel. The processor 110 may determine the Green value of the corresponding pixel by calculating a value of S_{HV} from the scattering data of the pixel. The processor 110 may determine the Blue value by calculating a value of S_{HH}+S_{VV} from the scattering data of the pixel. The processor 110 may determine the RGB value of the pixel on the polarization image corresponding to the location of each pixel of the input radar image according to the second exemplary embodiment.

In a third exemplary embodiment of the decomposition operation for creating the polarization image according to the present disclosure, the processor 110 may determine the RGB value for each of the plurality of pixels included in the input radar image. The processor 110 may determine the Red value of the corresponding pixel by calculating a value of S_{VV} from the scattering data of the pixel. The processor 110 may determine the Green value of the corresponding pixel by calculating a value of S_{VH} from the scattering data of the pixel. The processor 110 may determine the Blue value by calculating a value of S_{VV}/S_{VH} from the scattering data of the pixel. The processor 110 may determine the RGB value of the pixel on the polarization image corresponding to the location of each pixel of the input radar image according to the third exemplary embodiment. When the processor 110 creates the polarization image from the input radar image according to the third exemplary embodiment, the computing device 100 according to the present disclosure may create the polarization image even for the input radar image having only two types of radar signal values for each pixel.

$$\begin{matrix}α = \frac{{S}_{HH} + {S}_{VV}}{\sqrt{2}} & [ Equation 2 ] \\ β = \frac{{S}_{HH} + {S}_{VV}}{\sqrt{2}} & [ Equation 3 ] \\ γ = \sqrt{2} \times {S}_{HV} & [ Equation 4 ]\end{matrix}$$

α, β, γ represented in Equations 2 to 4 are real number values. Each of α, β, γ may be calculated by the processor 110 according to a corresponding equation among the equations represented in Equations 2 to 4 from the scattering data for each pixel. The processor 110 may determine the Red value of the corresponding pixel by squaring a α value calculated according to Equation 2. The processor 110 may determine the Green value of the corresponding pixel by squaring a γ value calculated according to Equation 4. The processor 110 may determine the Blue value of the corresponding pixel by squaring a β value calculated according to Equation 3. The processor 110 may determine the RGB value of the pixel on the polarization image corresponding to the location of each pixel of the input radar image according to a fourth exemplary embodiment.

The first to fourth exemplary embodiments in which the processor 110 creates the polarization image by performing the decomposition operation for the input radar image as described above are just various examples of creating the polarization image based on the decomposition operations of different schemes, and do not limit the method for creating the polarization image according to the present disclosure. The present disclosure includes various methods in which the processor 110 performs an arbitrary decomposition operation for the input radar image to determine the Red value, the Green value, and the Blue value for each of at least one pixel on the RGB image without a limitation.

In an exemplary embodiment of the present disclosure, the processor 110 may create a synthetic image through an image creation model based on the input radar image. The image creation model may be a model based on the artificial neural network. Contents regarding the image creation model which are duplicated with the contents described in FIG. 2 will be omitted and a difference will be primarily described.

In an exemplary embodiment of the present disclosure, the image creation model may be learned based on a generative adversarial network (GAN) learning algorithm. The image creation model may be learned mutually adversarially together with a separate image discrimination model.

In an exemplary embodiment of the present disclosure, a learning method for learning the image creation model may include a step in which the image creation model creates the synthetic image from the polarization image created based on the radar image and a step in which the image discrimination model discriminates an actual optical image photographed by an optical sensor and the synthetic image created by the image creation model. The image creation model and the image discrimination model may include at least one neural network layer. The image creation model may receive the polarization image created based on the radar image and create the synthetic image. In the present disclosure, the “actual optical image” may be interchangeably used with the “RGB image photographed by an optical lens”. In the present disclosure, the “synthetic image” may be interchangeably used with the “image created by the output of the image creation model”. The processor 110 may create the synthetic image so as to have a similar style to the actual optical image through the image creation model. The image discrimination model may be learned so as to well distinguish an output image created by the image creation model and the actual optical image. In this case, the image creation model may be learned so as not to distinguish the synthetic image and the actual optical image discrimination model. The image creation model and the image discrimination model may be learned mutually adversarially as such. The image discrimination model calculates a confidence score for an input image, and then compares a predetermined threshold and the confidence score to determine whether the input image is the actual optical image. During a learning process, the image input into the image discrimination model may be the synthetic image and may be the actual optical image. A detailed additional description for the generative adversarial neural network algorithm for learning the image creation model will be discussed in more detail in a prior thesis “Jun-Yan Zhu, Taesung Park, Phillip Isola, Alexei A. Efros, ‘Unpaired Image-to-Image Translation using Cycle-Consistent Adversarial Networks’ arXiv: 1703.10593, 2017”, the entire contents of which are incorporated herein by reference.

In an exemplary embodiment of the present disclosure, the step in which the processor 110 creates the synthetic image through the image creation model based on the input radar image may include a step of creating the synthetic image by inputting a first polarization image into the image creation model. Since the radar image is image data having not the RGB value for each pixel but the radar signal value for each pixel, the processor 110 may convert the input radar image into the RGB image for input data of the image creation model. The processor 110 may create the first polarization image by performing the first decomposition operation with respect to the input radar image in order to convert the input radar image into the RGB image. In addition, the processor 110 may create the synthetic image by inputting the created first polarization image into the image creation model.

In an exemplary embodiment of the present disclosure, the step in which the processor 110 creates the synthetic image through the image creation model based on the input radar image may include a step of creating a second polarization image by performing a second decomposition operation for the input radar image and a step of creating the synthetic image by inputting the second polarization image into the image creation model. In this case, the second decomposition operation may be based on a different algorithm from the first decomposition operation which the processor 110 performs to create the first polarization image. For example, the first decomposition operation which the processor 110 performs to create the first polarization image may be based on a VV value and an HH value in the radar signal included in the input radar image. In this case, the second decomposition operation which the processor 110 performs to create the second polarization image may be based on the HH value and a VH value in the radar signal included in the input radar image. As such, the first decomposition operation and the second decomposition operation may be distinguished according to the type of signal value which becomes a target of execution of the operation. As an additional example, the first decomposition operation may be based on the Pauli decomposition operation and the second decomposition operation may be based on the Cameron decomposition operation. As such, the first decomposition operation and the second decomposition operation may be distinguished according to an execution method of the operation. An example of the first decomposition operation and the second decomposition operation described above is just an example for the description and does not limit the present disclosure.

As described above, the processor 110 may create the synthetic image based on the second polarization image created based on the different decomposition operation from the first polarization image. When the synthetic image is created based on the second polarization image different from the first polarization image, the processor 110 has an advantage of being capable of creating result information based on data for differently processing the input radar image. Specifically, when the processor 110 creates the result information by overlapping the first polarization image and the synthetic image created based on the first polarization image, an additional operation for the second polarization image is not required, and as a result, an operation speed may be increased, but biased result information may be created in the first polarization image. On the contrary, when the processor 110 creates the result information by overlapping the first polarization image and the synthetic image created based on the second polarization image, the input radar image is interpreted through a different polarization image created in terms of different decomposition operations, and as a result, there is an effect that more accurate result information than an interpretation based on a single decomposition operation may be obtained.

In an exemplary embodiment of the present disclosure, the processor 110 may create result information through an image processing model based on the first polarization image and the synthetic image. For example, the processor 110 according to the present disclosure may create the result information by executing at least one task of a classification task, an object detection task, or a segmentation task for an image input through an image processing model. The result information may include a classification result for the input radar image. In this case, the classification result may be binary class classification result or a multi-class classification result. The result information may include a classification result for each of one or more pixels included in the input radar image. The result information may also include a size and coordinate data of an area where a target object is positioned within the input radar image. As described above, the type of task which may be executed through the image processing model is just some examples for the description, but does not limit the present disclosed contents, and the present disclosure includes various task types which may be executed based on at least a part of the convolutional operation of the neural network by receiving the image data without a limitation.

The processor 110 may calculate the confidence score for at least one of one or more pixels included in the input radar image through the image processing model. In this case, the confidence score calculated by the processor 110 may be a value indicating a degree at which at least one pixel corresponds to the target object. The processor 110 may calculate information such as whether the target object exists within input radar image or the location of the target object through a classification result for each of one or more pixels. The processor 110 may detect the target object which exists in the input radar image through the image processing model.

The processor 110 according to the present disclosure may create the result information by overlapping the first polarization image and the synthetic image, and inputting the overlapped images into the image processing model.

In an exemplary embodiment of the present disclosure, the processor 110 executes an addition operation or a subtraction operation for RGB values of two pixels positioned in the same coordinate of each of the first polarization image and the synthetic image to overlap the first polarization image and the synthetic image. In another exemplary embodiment of the present disclosure, the processor 110 calculates an average value for the RGB values of two pixels positioned in the same coordinate of each of the first polarization image and the synthetic image to overlap the first polarization image and the synthetic image. In yet another exemplary embodiment of the present disclosure, the processor 110 executes a weighted sum operation for the RGB values of two pixels positioned in the same coordinate of each of the first polarization image and the synthetic image to overlap the first polarization image and the synthetic image. The processor 110 may appropriately select a ratio of the RGB values of the first polarization image and the synthetic image in order to execute the weighted sum operation.

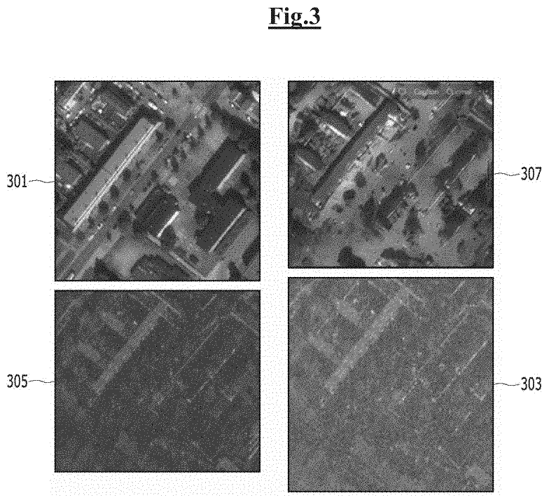

In the present disclosure, in an exemplary embodiment for overlapping the first polarization image and the synthetic image, the processor 110 may create a combination image by sequentially combining the first polarization image and the synthetic image. The processor 110 may sequentially combine both images in a channel axial direction of each image data. For example when a horizontal length of the first polarization image is W, a vertical length is H, the number of channels is C1, a horizontal length of the synthetic image is W, a vertical length is H, and the number of channels is C2, the processor 110 sequentially combines the first polarization image and the synthetic image in a channel direction to create a combination image in which the horizontal length is W, the vertical length is H, and the number of channels is (C1+C2). When both C1 and C2 values are 3 in order to express the RGB image, the processor 110 may create a combination image in which a size of the channel is 6 by sequentially combining the first polarization image and the synthetic image. When the processor 110 creates the combination image by sequentially combining the first polarization image and the synthetic image, and then inputs the created combination image into the image processing model, there is an effect that the image processing model is capable of simultaneously receiving a polarization image in which comparatively much basic information of the input radar image is preserved and a synthetic image in which a lot of auxiliary information for a contour or a color of each object which exists in the input radar image exists. That is, the image processing model independently receives information which exists in each of the polarization image and the synthetic image not to be damaged by the processor 110 to calculate more accurate result information. Hereinafter, an effect in the case of creating the result information through the image processing model based on the first polarization image and the synthetic image according to the present disclosure will be described with reference to FIG. 3.

FIG. 3 is an exemplary diagram illustrating a state of an image according to each step of image processing. An input radar image 303 may be illustrated to have different brightness for each pixel according to a magnitude of a received radar signal. An original image 301 may be an image acquired by photographing a photographing target with the optical lens. The original image 301 may be illustrated to have a different color for each pixel according to a photographing result. The input radar image 303 illustrated in FIG. 3 represents an image when a region corresponding to the original image 301 is photographed by radar equipment. The polarization image 305 may be an image created as a result of executing the decomposition operation for the input radar image 303. A synthetic image 307 may be an image created through the image creation model based on the input radar image 303. The synthetic image 307 may be an image created as a result of inputting the polarization image 305 into the image creation model. The synthetic image 307 may also be created from an RGB image acquired as a result of executing a different decomposition operation from the decomposition operation for creating the polarization image 305 for the input radar image 303.

According to the present disclosure, the processor 110 may acquire more accurate result information for the input radar image 303 by overlapping the polarization image 305 and the synthetic image 307, and inputting the images into the image processing model. First, each image property is as follows. Since the simple polarization image 305 is acquired by executing the decomposition operation for the radar image, areas having a magnitude of a similar radar signal value within the input radar image 303 have a similar RGB value within the polarization image 305. However, since the radar signal value is a value which is not distinguished according to an object, but according to a surface property, there is a problem in that a set of areas having the similar RGB value within the polarization image 305 does not represent a specific object. For example, referring to the polarization image 305 of FIG. 3, the RGB value of each area may be different even though the polarization image 305 corresponds the same ‘building’. A case of such a problem may be a creation scheme of the polarization image 305, which executes the decomposition operation for the radar signal value and allocates a result of a specific calculation to each of Red, Green, and Blue. Accordingly, the processor 110 may not normally create meaningful result information from the input radar image 303 only by the polarization image 305.

Meanwhile, since the synthetic image 307 created through the image creation model grants a different RGB value for each object, distinguishing of the object according to the RGB value may be easier than the polarization image 305. Specifically, in the synthetic image 307, a building roof, a road, a tree, etc., have different RGB values, and this allows the processor 110 to determine a boundary of the object or detect the object more easily by comparison with the polarization image 305. However, when the processor 110 creates the result information through the image processing model by using only the synthetic image 307, there are a lot of processing steps for the input radar image 303, and as a result, the information is distorted and accurate result information may not be created.

Accordingly, disclosed is a method in which the processor 110 of the present disclosure normally preserves data of the input radar image 303, but overlaps the polarization image 305 having severe noise and the synthetic image 307 playing an auxiliary role or creating the result information by announcing contour, color information, etc., of the object in the input radar image, and inputting the images into the image processing model to create the more accurate result information for the input radar image 303. That is, the processor 110 sequentially combines the polarization image 305 and the synthetic image 307, and inputs the images into the image processing model to acquire accurate positional information of the target object included in the input radar image from the polarization image 305, and acquire contour information or color information of the target object included in the input radar image from the synthetic image 307. As a result, the processor 110 may more accurately detect the target object from the input radar image 303.

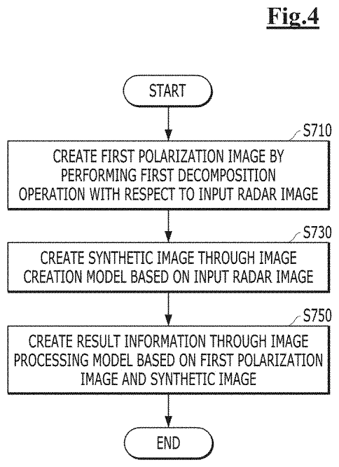

FIG. 4 is a flowchart for a process of creating result information from an input radar image by a computing device according to an exemplary embodiment of the present disclosure. The processor 110 may create a first polarization image by performing a first decomposition operation with respect to the input radar image in step S710. The processor 110 may create a synthetic image through an image creation model based on the input radar image in step S730. The image creation model may be an artificial neural network model that executes a task of converting the input image to have a similar style to the actual optical image. The image creation model may be learned based on a generative adversarial neural network algorithm. The synthetic image may be created as a result of inputting the first polarization image into the image creation model. The synthetic image may be created as a result of inputting the second polarization image into the image creation model. In this case, the second polarization image may be based on a different algorithm from the first polarization image. Steps S710 and S730 may be executed by the processor 110 in sequence or in parallel to each other. The processor 110 may create result information through an image processing model based on the first polarization image and the synthetic image in step S750. The processor 110 may create the result information by overlapping the first polarization image and the synthetic image, and inputting the overlapped images into the image processing model. The processor 110 may also input a combination image created by sequentially combining the first polarization image and the synthetic image into the image processing model. The result information created by the processor 110 may include information on the target object included in the input radar image. The result information may include positional information of a pixel corresponding to the target object.

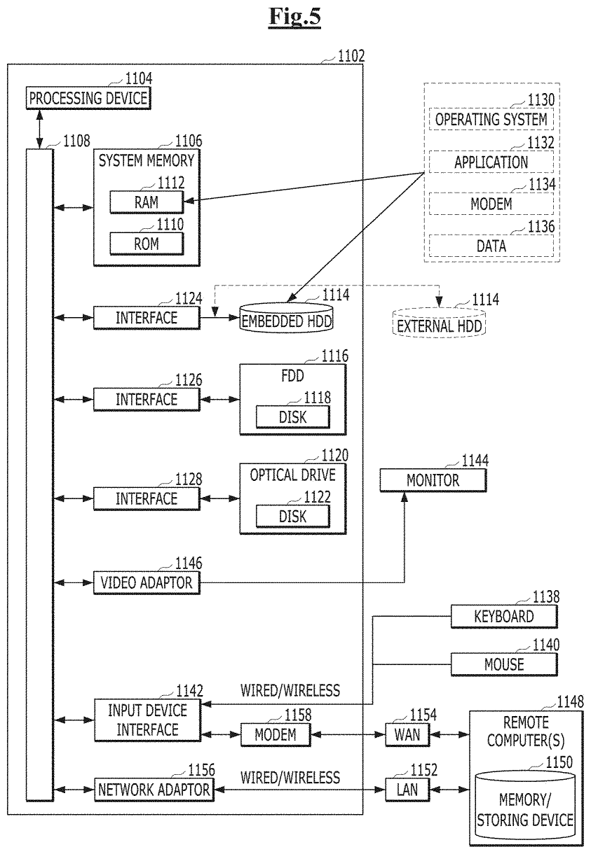

FIG. 5 is a normal and schematic view of an exemplary computing environment in which the exemplary embodiments of the present disclosure may be implemented. It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for processing a radar image performed by a computing device including at least one processor, the method comprising:
creating a first polarization image by performing a first decomposition operation with respect to an input radar image;
creating a synthetic image through an image creation model based on the input radar image; and
creating result information through an image processing model based on the first polarization image and the synthetic image.

2. The method of claim 1, wherein the creating of the result information includes overlapping the first polarization image and the synthetic image, and inputting the images into the image processing model.

3. The method of claim 1, wherein the input radar image is a synthetic aperture radar (SAR) image.

4. The method of claim 1, wherein the image creation model is learned based on a generative adversarial neural network algorithm.

5. The method of claim 1, wherein the image creation model is learned based on a learning method including
creating, by the image creation model, the synthetic image from a polarization image created based on a radar image, and
discriminating, by an image discrimination model, an actual optical image photographed through an optical sensor, and the synthetic image.

6. The method of claim 1, wherein the creating of the synthetic image includes creating the synthetic image by inputting the first polarization image into the image creation model.

7. The method of claim 1, wherein the creating of the synthetic image includes
creating a second polarization image by performing a second decomposition operation with respect to the input radar image, and
creating the synthetic image by inputting the second polarization image into the image creation model, and
the second decomposition operation is based on a different algorithm from the first decomposition operation.

8. The method of claim 1, wherein the first decomposition operation or the second decomposition operation includes an operation of decomposing scattering data for at least one pixel included in the input radar image.

9. The method of claim 1, wherein the result information includes a classification result for each of one or more pixels included in the input radar image.

10. The method of claim 2, wherein the inputting includes creating a combination image by sequentially combining the first polarization image and the synthetic image.

11. A computer program stored in a computer-readable storage medium, wherein the computer program executes the following operations for processing a radar image when the computer program is executed by one or more processors, the operations comprising:
creating a first polarization image by performing a first decomposition operation with respect to an input radar image;
creating a synthetic image through an image creation model based on the input radar image; and
creating result information through an image processing model based on the first polarization image and the synthetic image.

12. An apparatus for processing a radar image, the apparatus comprising:
one or more processors;
a memory storing an image creation model including one or more neural networks and an image processing model including one or more neural networks; and
a network unit,
wherein the one or more processors are configured to
create a first polarization image by performing a first decomposition operation with respect to an input radar image,
create a synthetic image through an image creation model based on the input radar image, and
create result information through an image processing model based on the first polarization image and the synthetic image.
